(19) United States
(12) Patent Application Publication
(10) Pub. No.: US 2026/0148335 A1
(43) Pub. Date: May 28, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: HIDENORI ITO, Tokyo (JP)

(21) Appl. No.: 19/454,030

(22) Filed: Jan. 20, 2026

Related U.S. Application Data
(63) Continuation of application No. PCT/JP2024/025191, filed on Jul. 12, 2024.

(30) Foreign Application Priority Data
Jul. 25, 2023 (JP) 2023-120608

(51) Int. Cl. G06T 3/40; G06T 7/20; G06T 15/08; G06T 15/20; G06T 17/00

(52) U.S. Cl. CPC G06T 3/40; G06T 7/20; G06T 15/08; G06T 15/20; G06T 17/00; G06T 2207/30196; G06T 2207/30221; G06T 2210/08; G06T 2210/12; G06T 2210/56

(57) ABSTRACT

An information processing apparatus acquires information about a transmission bandwidth available for data transmission, a three-dimensional model of an object in a three-dimensional space, and movement information about at least either the object or a virtual point of view in the three-dimensional space. The information processing apparatus then determines a transmission data generation method based on the information about the transmission bandwidth and the movement information, and generates transmission data on the three-dimensional model or transmission data on a two-dimensional image generated from the three-dimensional model, based on the determination transmission data generation method.

### CROSS-REFERENCE TO RELATED APPLICATIONS

This application is a Continuation of International Patent Application No. PCT/JP 2024/025191, filed Jul. 12, 2024, which claims the benefit of Japanese Patent Application No. 2023-120608, filed Jul. 25, 2023, both of which are hereby incorporated by reference herein in their entirety.

### BACKGROUND

### Field of the Technology

The present disclosure relates to an information processing technique for generating transmission data.

### Description of the Related Art

Techniques for generating three-dimensional models from object images captured from multiple points of view using a plurality of different imaging apparatuses (hereinafter, referred to as cameras), and generating an image (hereinafter, referred to as virtual point of view image) as seen from a virtual point of view using the three-dimensional models have been known. An example of a system configuration for users to view this virtual point of view image is where a server generates transmission data such as three-dimensional models or virtual point of view images, and transmits the transmission data to user terminals. However, in this system configuration, the data volume of the transmission data may exceed the transmission bandwidth, resulting in unintended image loss or the like.

In view of this, Japanese Patent Laid-Open No. 2019-54488 describes a technique that can efficiently reduce the data volume of three-dimensional model data for reproducing a virtual point of view. According to the technique described in Japanese Patent Laid-Open No. 2019-54488, a plurality of hierarchical levels of model data with different data volumes is generated for each object, and transmission data is configured using model data of levels determined object by object based on attribute data that associates content attributes with required levels.

According to the foregoing Japanese Patent Laid-Open No. 2019-54488, the data volume of transmission data can be reduced to fall within the transmission bandwidth. However, a technique that enables more efficient reduction of the data volume of transmission data is desired.

### SUMMARY

The present disclosure is directed to enabling more efficient reduction of the data volume of transmission data.

According to an aspect of the present disclosure, an information processing apparatus includes a bandwidth information acquisition unit configured to acquire information about a transmission bandwidth available for data transmission, a model acquisition unit configured to acquire a three-dimensional model of an object in a three-dimensional space, a movement information acquisition unit configured to acquire movement information about at least either the object or a virtual point of view in the three-dimensional space, a determination unit configured to determine a transmission data generation method based on the information about the transmission bandwidth and the movement information, and a data generation unit configured to generate transmission data on the three-dimensional model or transmission data on a two-dimensional image generated from the three-dimensional model, based on the transmission data generation method.

Features of the present disclosure will become apparent from the following description of embodiments with reference to the attached drawings.

### BRIEF DESCRIPTION OF THE DRAWINGS

FIG. 1 is a diagram illustrating a configuration example of an entire system according to embodiments.

FIG. 2 is an explanatory diagram illustrating a use case of the system according to the embodiments.

FIG. 3 is a diagram illustrating a functional configuration example of a transmission data generation unit according to the first embodiment.

FIG. 4 is a diagram illustrating a hardware configuration example of the transmission data generation unit.

FIG. 5 is a flowchart of transmission data generation processing according to the first embodiment.

FIG. 6 is a flowchart of transmission data reduction method determination processing according to the first embodiment.

FIG. 7 is an explanatory diagram of a temporal resolution reduction method according to the first embodiment.

FIG. 8 is an explanatory diagram of a spatial resolution reduction method according to the first embodiment.

FIG. 9 is a diagram illustrating specific examples in determining a data volume reduction method according to the first embodiment.

FIG. 10 is a diagram illustrating a configuration example of a transmission data generation unit according to a second embodiment.

FIG. 11 is a flowchart of transmission data generation processing according to the second embodiment.

FIG. 12 is a flowchart of transmission data reduction method determination processing according to the second embodiment.

FIG. 13 is a diagram illustrating specific examples in determining a data volume reduction method according to the second embodiment.

### DESCRIPTION OF THE EMBODIMENTS

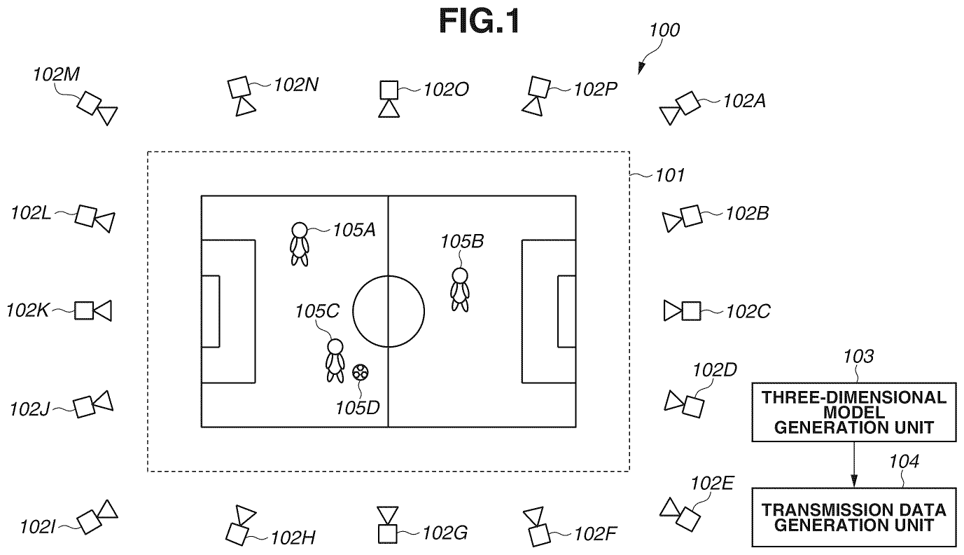

Embodiments according to the present disclosure will hereinafter be described with reference to the drawings. The following embodiments are not intended to limit the present disclosure, and not all combinations of features are necessarily essential to the solving means of the present disclosure. The configurations of the embodiments may be modified or changed as appropriate depending on the specifications of the apparatuses to which the present disclosure is applied and various conditions (use conditions, use environment, and the like). In the following embodiments, identical or similar configurations and processing steps are denoted by the same reference numerals, and redundant descriptions thereof will be omitted. Reference numerals that are assigned to identical or similar configurations and differ only in the alphabetic characters appended at the end of the numbers shall represent different instances of configurations having the same function. For example, a camera 102A and a camera 102B in FIG. 1 to be described below are different instances having the same function. “Having the same function” refers to having at least a specific function (in the case of cameras, an imaging function or the like). For example, the camera 102A and the camera 102B may differ in some of their functions and performance.

### First Embodiment

FIG. 1 is a diagram illustrating a configuration example of an entire system 100 to which an information processing apparatus according to the present embodiment is applied. The system 100 according to the present embodiment includes a plurality of imaging apparatuses (referred to as cameras 102A to 102P), a three-dimensional model generation unit 103, and a transmission data generation unit 104. The cameras 102A to 102P and the three-dimensional model generation unit 103, and the three-dimensional model generation unit 103 and the transmission data generation unit 104, are connected by a not-illustrated local area network (LAN). The connection mode is not limited to a LAN, and may be either wired or wireless.

The cameras 102A to 102P are located at respective different positions around a field 101 that is an example of an imaging target. Objects to be three-dimensionally modeled are on the field 101. Take, for example, a sport (in the example of FIG. 1, soccer) as an example of the imaging target. In such a case, objects include players playing the sport, as well as equipment, devices, and tools. In the example of FIG. 1, soccer players and a ball, which are the objects, are schematically illustrated as three-dimensional modeling targets 105A to 105D. The cameras 102A to 102P will hereinafter be referred to simply as cameras 102, and the three-dimensional modeling targets 105A to 105D simply as three-dimensional modeling targets 105, unless specific description is needed. The cameras 102 transmit all or part of their captured images to the three-dimensional model generation unit 103.

The three-dimensional model generation unit 103 is a server that performs three-dimensional model generation processing using the images acquired from the cameras 102. The three-dimensional model generation unit 103 performs shape estimation processing for generating three-dimensional models needed to generate a virtual point of view image, using the images captured by the cameras 102. The shape estimation processing uses a visual hull method, for example. As the visual hull method processing, the three-dimensional model generation unit 103 initially fills the target space of the three-dimensional model generation with unit-volume rectangular parallelepipeds called voxels. The three-dimensional model generation unit 103 then projects the foreground silhouettes of objects of interest extracted from the captured image of each camera 102 onto the voxel group in the imaging range of the camera 102, and removes voxels outside the foreground silhouettes. The three-dimensional model generation unit 103 generates three-dimensional models by performing such processing for all the cameras 102. At the same time, the three-dimensional model generation unit 103 colors the three-dimensional models by attaching texture images to the three-dimensional models generated as described above, with image information included in the foreground silhouettes from the cameras 102 as the texture images. In the following description of the embodiment, three-dimensional models are described as three-dimensional point clouds that are sets of colored voxels. It will be understood that three-dimensional models are not limited thereto, and may be three-dimensional models using three-dimensional polygon meshes, for example.

The transmission data generation unit 104 is an application example of the information processing apparatus according to the present embodiment, and is a server that generates transmission data to be transmitted to user terminals from the three-dimensional models generated by the three-dimensional model generation unit 103. The transmission data generation unit 104 according to the present embodiment generates the transmission data from three-dimensional model data (data of the three-dimensional point clouds that are sets of colored voxels) generated by the three-dimensional model generation unit 103, and transmits the generated transmission data to user terminals. The transmission data generation unit 104 may generate transmission data from two-dimensional image data that is generated by performing rendering using virtual point of view information indicating the position and line of sight direction of a virtual point of view, and transmit the generated transmission data to user terminals.

The present embodiment will be described by using an example where transmission data is generated from unrendered three-dimensional model data (data of three-dimensional point clouds that are sets of colored voxels) and transmitted to user terminals. If unrendered three-dimensional model data is thus transmitted to user terminals, the user terminals perform rendering processing to generate a virtual point of view image that is a two-dimensional image, and display the virtual point of view image. The information processing apparatus according to the present embodiment may include not only the transmission data generation unit 104 but the foregoing three-dimensional model generation unit 103 as well.

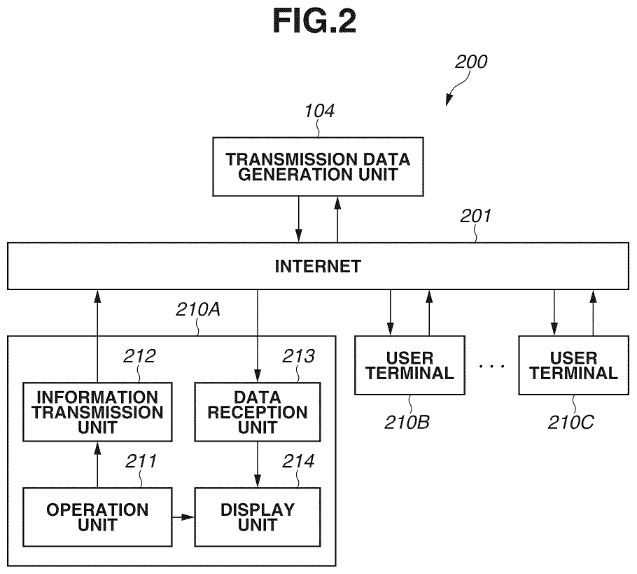

FIG. 2 is a diagram illustrating an example of a use case 200 where transmission data generated by the transmission data generation unit 104 is transmitted to user terminals 210A to 210C, and the user terminals 210A to 210C generate a virtual point of view image from the transmission data and display the virtual point of view image. As illustrated in FIG. 2, the transmission data generation unit 104 is connected to the user terminals 210A to 210C via the Internet 201. The user terminals 210A to 210C will hereinafter be referred to simply as user terminals 210, unless specific description is needed. The user terminals 210 each include the functions of a data reception unit 213, a display unit 214, an operation unit 211, and an information transmission unit 212. The transmission path is not limited to the Internet 201. Any given network to which the server that generates the transmission data (transmission data generation unit 104) and client terminals that display virtual point of view images (user terminals 210) are connected may be used.

The operation unit 211 acquires the position of a virtual point of view from which the user wishes to view images and a line of sight direction from the virtual point of view, in other words, the position and imaging direction of a virtual camera as operation information input by the user of the user terminal 210. Examples of the operation unit 211 that can acquire the position and direction of the virtual point of view include input devices capable of specifying a three-dimensional spatial position and direction, such as joystick-and game controller-type devices. Other examples of the operation unit 211 may include a head-mounted display incorporating sensors capable of detecting the direction in which the user's face is oriented (line of sight direction) when the user wears the head-mounted display on their head.

The virtual point of view information including the position and direction of the virtual point of view input by the user via the operation unit 211 is sent to the display unit 214 or the information transmission unit 212. For example, in the case where transmission data of three-dimensional model data is transmitted from the transmission data generation unit 104, the virtual point of view information is sent to the display unit 214. For example, in the case where transmission data of two-dimensional image data is transmitted from the transmission data generation unit 104, the virtual point of view information is sent to the information transmission unit 212.

In a second embodiment to be described below, the virtual point of view information is also sent to the information transmission unit 212.

The information transmission unit 212, when the virtual point of view information is sent from the operation unit 211, transmits the virtual point of view information to the transmission data generation unit 104 via the Internet 201.

The data reception unit 213 of the user terminal 210, when receiving transmission data from the transmission data generation unit 104, sends the transmission data to the display unit 214.

The display unit 214 displays a virtual point of view image based on the transmission data received by the data reception unit 213. For example, in the case where transmission data of three-dimensional model data is transmitted from the transmission data generation unit 104, the display unit 214 generates a virtual point of view image (two-dimensional image) by performing rendering processing based on the three-dimensional model data and the virtual point of view information acquired by the operation unit 211, and displays the virtual point of view image. For example, in the case where two-dimensional image data (virtual point of view image) is transmitted from the transmission data generation unit 104, the display unit 214 displays the virtual point of view image.

The transmission data generation unit 104, in the case of transmitting transmission data of three-dimensional model data, for example, generates transmission data on the three-dimensional models transmitted from the three-dimensional model generation unit 103, and transmits the transmission data to the user terminals 210. In the case of transmitting transmission data of two-dimensional image data, for example, the transmission data generation unit 104 receives virtual point of view information transmitted from a user terminal 210, and generates two-dimensional image data by performing rendering using the virtual point of view information and the three-dimensional model. The transmission data generation unit 104 then transmits the transmission data of the two-dimensional image data to the user terminal 210.

Here, the transmission data generation unit 104 according to the first embodiment, when generating transmission data, acquires transmission bandwidth information indicating an available transmission bandwidth of the transmission path (hereinafter, may be referred to as available transmission bandwidth information) and movement information about objects in the three-dimensional space. Based on the available transmission bandwidth information and the movement information about the objects, the transmission data generation unit 104 then generates transmission data with a data volume within the available transmission path. In other words, if the volume of the transmission data exceeds the available transmission bandwidth, the transmission data generation unit 104 reduces the volume of the transmission data to within the available transmission bandwidth.

Now, the processing for generating transmission data by the transmission data generation unit 104 according to the present embodiment will be described by using a case where the transmission data is three-dimensional model data as an example. A case where the transmission data is rendered two-dimensional image data will be described below.

Three-dimensional model data is data representing the three-dimensional modeling targets 105 illustrated in FIG. 1 described above as three-dimensional point clouds, and is point cloud data of each object existing in a continuous area of three-dimensional space. The transmission data generation unit 104 can thus acquire position information (object position information) about a three-dimensional modeling target 105 of interest in the three-dimensional space by calculating the geometric mean position of a continuous three-dimensional point cloud corresponding to the three-dimensional modeling target 105. The three-dimensional model data is also time-series data generated by the three-dimensional model generation unit 103 from images successively acquired by the cameras 102 frame by frame in chronological order. The transmission data generation unit 104 can thereby acquire the position information about each three-dimensional modeling target 105 in chronological order, and can acquire movement information indicating the movement of the three-dimensional modeling target 105 using the position information in chronological order. In other words, the transmission data generation unit 104 can acquire movement information about objects such as the players and tools in FIG. 1.

While the present embodiment deals with an example of acquiring the movement information from the three-dimensional model data, this is not restrictive. The three-dimensional model generation unit 103 or the transmission data generation unit 104 may acquire movement information about objects and the like from images successively captured by the cameras 102.

There are various existing techniques for acquiring movement (motion) information about objects and the like from images captured by the cameras 102, and any of such techniques may be used.

The transmission data generation unit 104 also acquires transmission bandwidth information indicating the available transmission bandwidth based on the usage of the Internet 201 and transmission bandwidths allocated in advance to the transmission data generation unit 104 and the user terminal 210. For example, the available transmission bandwidth information is a value indicating the volume of data that can be transmitted per unit time, expressed in units such as bytes/second (hereinafter, referred to as B/sec).

The transmission data generation unit 104 according to the present embodiment acquires the movement information about the three-dimensional modeling targets 105 and the transmission bandwidth information indicating the available transmission bandwidth, and determines the method (hereinafter, may be referred to as transmission data generation method) for generating transmission data within the available transmission bandwidth based on such information. The transmission data generation unit 104 then generates transmission data within the available transmission bandwidth from the three-dimensional model data, using the determined transmission data generation method.

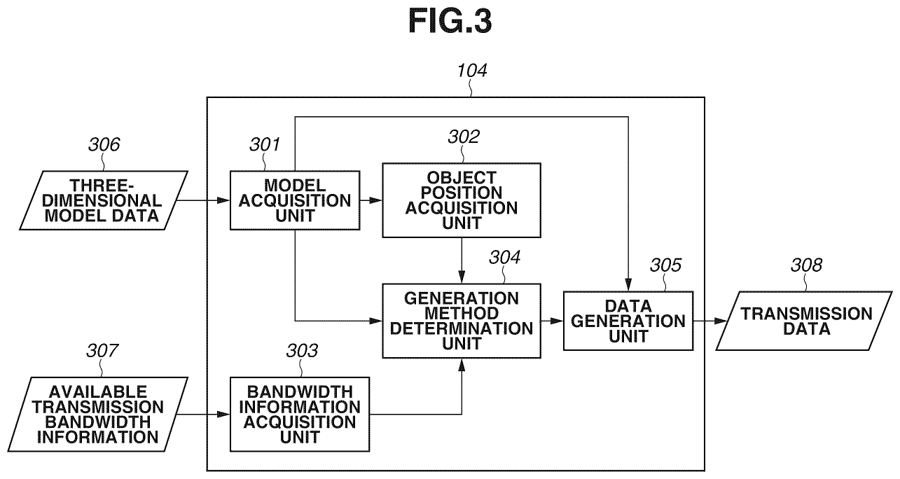

FIG. 3 is a diagram illustrating a functional configuration example of the transmission data generation unit 104 according to the present embodiment, which can acquire the movement information about the three-dimensional modeling targets 105 and the transmission bandwidth information indicating the available transmission bandwidth and generate transmission data within the available transmission bandwidth based on such information.

A model acquisition unit 301 acquires three-dimensional model data 306 generated by the three-dimensional model generation unit 103, and outputs the three-dimensional model data 306 to an object position acquisition unit 302, a generation method determination unit 304, and a data generation unit 305. The three-dimensional model data 306 acquired by the model acquisition unit 301 is also stored into a storage device such as a not-illustrated random access memory (RAM) provided in the transmission data generation unit 104, and used for subsequent processing. In the present embodiment, the storage device successively stores pieces of past three-dimensional model data 306 for at least a certain period from the present (current point in time).

The object position acquisition unit 302 detects the current positions of the three-dimensional modeling targets 105 in the three-dimensional space based on the three-dimensional model data 306 received from the model acquisition unit 301. As described above, the object position acquisition unit 302 acquires the position information about the three-dimensional modeling targets 105 within the three-dimensional space, i.e., the position information about the objects by calculating the geometric mean positions of the continuous three-dimensional point clouds corresponding to the three-dimensional modeling targets 105. The object position acquisition unit 302 stores the acquired position information into the foregoing storage device. The current position information about the objects acquired by the object position acquisition unit 302 and the past position information for a certain period from the present, already stored in the storage device are then sent to the generation method determination unit 304.

A bandwidth information acquisition unit 303 acquires available transmission bandwidth information 307 and sends the available transmission bandwidth information 307 to the generation method determination unit 304. As described above, the available transmission bandwidth information 307 is a value indicating the volume of data that can be transmitted per unit time, expressed in units such as B/sec, for example. The available transmission bandwidth information 307 is acquired based on the usage of the Internet 201 illustrated in FIG. 2 and the values allocated in advance.

The generation method determination unit 304 acquires the movement information about the objects based on the current position information acquired by the object position acquisition unit 302 and the past position information for a certain period, stored in the storage device. The generation method determination unit 304 determines the transmission data generation method to be used when the data generation unit 305 in the subsequent stage generates transmission data, based on the movement information about the objects, the three-dimensional model data 306, and the available transmission bandwidth information 307. Details of the processing for determining the transmission data generation method by the generation method determination unit 304 will be described below. The generation method determination unit 304 sends information indicating the determined transmission data generation method to the data generation unit 305.

The data generation unit 305 generates transmission data 308 from the three-dimensional model data 306 based on the transmission data generation method determined by the generation method determination unit 304, and transmits the transmission data 308 to the user terminal 210. If the transmission data is generated from two-dimensional image data, the data generation unit 305 generates the transmission data from two-dimensional image data that is generated through rendering based on the three-dimensional model data 306 and virtual point of view information transmitted from the user terminal 210. Details of the transmission data generation processing by the data generation unit 305 will be described below.

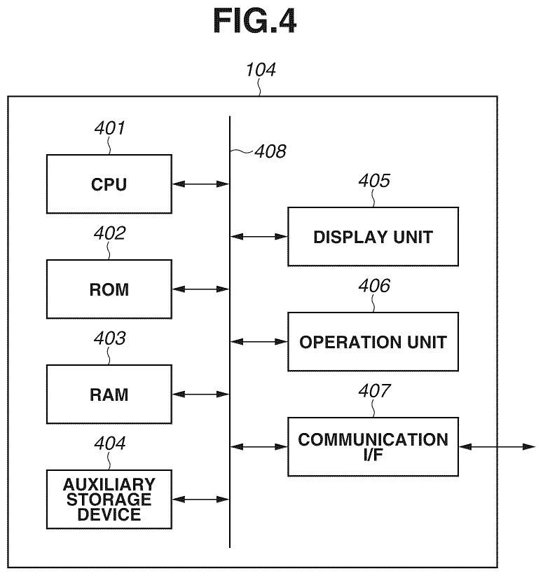

Next, a hardware configuration example of the transmission data generation unit 104 will be described with reference to FIG. 4. As illustrated in FIG. 4, the hardware configuration of the transmission data generation unit 104 includes a central processing unit (CPU) 401, a read-only memory (ROM) 402, a RAM 403, an auxiliary storage device 404, a display unit 405, an operation unit 406, a communication interface (I/F) 407, and a bus 408.

The CPU 401 implements the functional units of the transmission data generation unit 104 illustrated in FIG. 3 by controlling the entire transmission data generation unit 104 using an information processing program according to the present embodiment and data, which are stored in the ROM 402 or the auxiliary storage device 404. The transmission data generation unit 104 may include one or more pieces of dedicated hardware different from the CPU 401, and at least part of the processing of the CPU 401 may be performed by such dedicated hardware. Examples of the dedicated hardware include an application-specific integrated circuit (ASIC), a field-programmable gate array (FPGA), and a digital signal processor (DSP).

The ROM 402 stores programs and the like that do not need to be changed. The RAM 403 temporarily stores programs and data supplied from the ROM 402 and the auxiliary storage device 404, data supplied from output via the communication I/F 407, etc. The auxiliary storage device 404 includes a hard disk drive, for example, and stores various types of data such as image data and audio data. The information processing program according to the present embodiment is stored in the ROM 402 or the auxiliary storage device 404, loaded into the RAM 403, and executed by the CPU 401. The foregoing storage device provided in the transmission data generation unit 104 refers to the RAM 403.

The display unit 405 includes a liquid crystal display and a light-emitting diode (LED), for example, and displays a graphical user interface (GUI) and the like for the user to operate the transmission data generation unit 104. The CPU 401 also operates as a display control unit that controls the display unit 405.

The operation unit 406 includes a keyboard, a mouse, a joystick, and/or a touchscreen, for example. The operation unit 406 receives user operations and inputs various instructions to the CPU 401. The CPU 401 also operates as an operation control unit that controls the operation unit 406.

The communication I/F 407 is used when the transmission data generation unit 104 communicates with external devices and the like. For example, if the transmission data generation unit 104 is connected to an external device in a wired manner, the communication cable is connected to the communication I/F 407. If the transmission data generation unit 104 has a function of wirelessly communicating with external devices, the communication I/F 407 includes an antenna.

A bus 408 connects the components of the transmission data generation unit 104 and transmits information.

While FIG. 4 illustrates an example where the display unit 405 and the operation unit 406 are included in the transmission data generation unit 104, at least one of the display unit 405 and the operation unit 406 may exist as a separate device outside the transmission data generation unit 104.

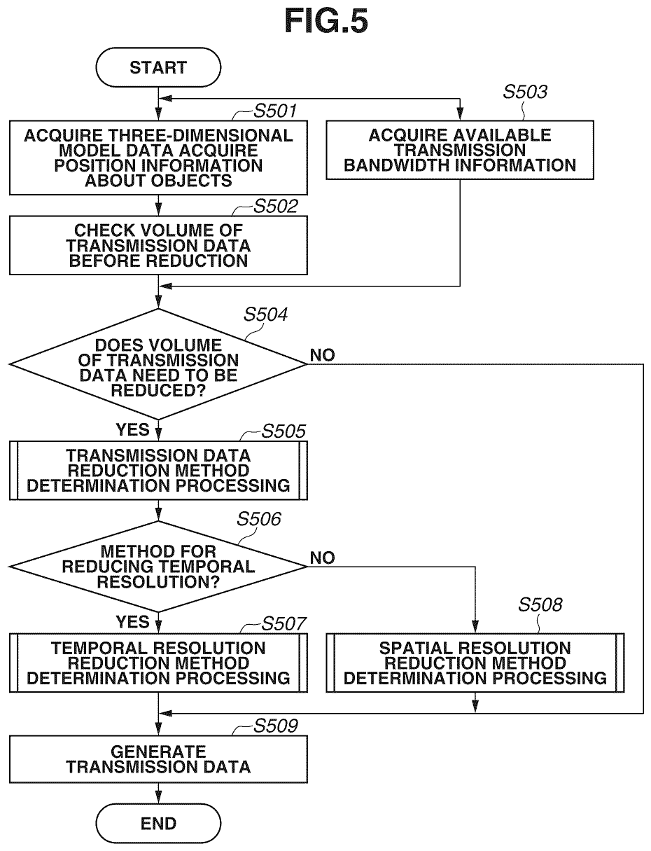

Now, processing where the transmission data generation unit 104 according to the first embodiment generates transmission data from the three-dimensional model data 306 based on the three-dimensional model data 306, the movement information about the objects, and the available transmission bandwidth information 307 will be described with reference to FIGS. 5 to 8.

FIG. 5 is a flowchart illustrating a procedure for the transmission data generation processing performed by the transmission data generation unit 104 illustrated in FIG. 3. In the following description of flowcharts, the symbol S shall represent a processing step.

In step S501, the model acquisition unit 301 acquires the three-dimensional model data 306 from the three-dimensional model generation unit 103 as described above. The model acquisition unit 301 then outputs the three-dimensional model data 306 to the object position acquisition unit 302, the generation method determination unit 304, and the data generation unit 305. The model acquisition unit 301 also stores the three-dimensional model data 306 into the storage device (RAM 403). After this step S501, the processing proceeds to step S502.

Meanwhile, in step S501, the object position acquisition unit 302 acquires the position information about the objects that are the three-dimensional modeling targets 105. As described above, the object position acquisition unit 302 detects the current positions of the objects that are the three-dimensional modeling targets 105 from the three-dimensional model data 306.

The object position acquisition unit 302 successively stores the position information about the objects into the foregoing storage device.

In step S502, the generation method determination unit 304 checks the volume of transmission data before reduction. In the present embodiment, the volume of transmission data before reduction refers to that of transmission data in a case where the temporal resolution and spatial resolution of certain three-dimensional model data 306 are at their default values when the three-dimensional models are generated by the three-dimensional model generation unit 103. The present embodiment will be described on the assumption that the default value of the temporal resolution is 60 frames per second (fps) and the default value of the spatial resolution is 1 mm/voxel. In other words, in step S502, the generation method determination unit 304 checks that the volume of transmission data before reduction is the data volume at 60 fps and 1 mm/voxel. After this step S502, the processing proceeds to step S504.

In step S503, which is performed in parallel with or before the foregoing step S501, the bandwidth information acquisition unit 303 acquires the available transmission bandwidth information 307. As described above, the unit of the available transmission bandwidth is the volume of data per unit time, such as MB/sec. In the present embodiment, with the time of one frame as the unit time, the bandwidth information acquisition unit 303 converts the available transmission bandwidth into the volume of data per frame. For example, if the available transmission bandwidth is 120 MB/sec and the temporal resolution is 60 fps, the volume of data per frame is 2 Mbytes. The bandwidth information acquisition unit 303 then transmits the information indicating the volume of transmission data obtained by converting the available transmission bandwidth information 307 into the volume of data per frame to the generation method determination unit 304. After this step S503, the processing proceeds to step S504.

In step S504, the generation method determination unit 304 determines whether the volume of transmission data needs to be reduced (data volume reduction necessity determination processing), based on the volume of transmission data before reduction checked in step S502 and the available transmission bandwidth information 307 acquired by the bandwidth information acquisition unit 304 in step S503. The processing then branches depending on the determination result. For example, if the volume of transmission data before reduction is less than or equal to the volume of data that can be transmitted with the available transmission bandwidth, the generation method determination unit 304 determines that the volume of transmission data does not need to be reduced (NO in step S504). In other words, in such a case, the generation method determination unit 304 does not change the temporal and spatial resolutions from the default values. On the other hand, if the volume of transmission data before reduction exceeds the volume of data that can be transmitted with the available transmission bandwidth (YES in step S504), the processing proceeds to step S505.

In step S505, the generation method determination unit 304 determines the method for reducing the volume of transmission data.

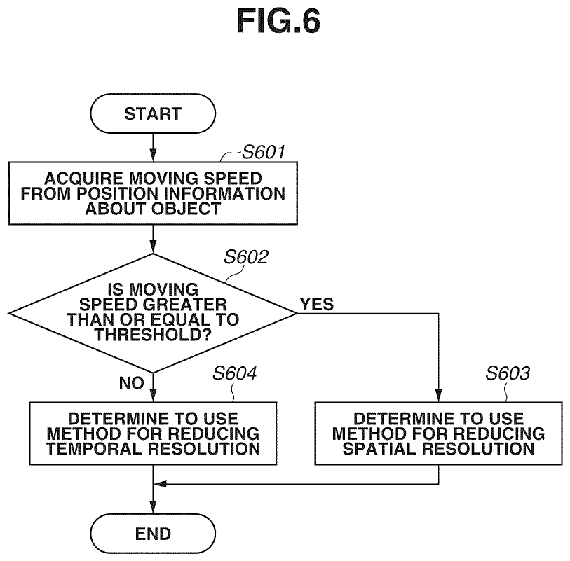

FIG. 6 is a flowchart illustrating a detailed procedure for transmission data reduction method determination processing that the generation method determination unit 304 performs in step S505 of FIG. 5.

In step S601 of FIG. 6, the generation method determination unit 304 performs object movement information acquisition processing. More specifically, the generation method determination unit 304 acquires the movement information about the objects (three-dimensional modeling targets 105) based on the current position information about the objects acquired by the object position acquisition unit 302 and the position information for a certain period stored in the storage device. The generation method determination unit 304 according to the present embodiment calculates moving speeds as the movement information about the objects. For example, the generation method determination unit 304 acquires position information about a certain object of interest at two times, and calculates the moving speed from the temporal difference between the pieces of object position information at the two times. Moreover, for example, the generation method determination unit 304 may calculate the moving speed using pieces of position information on an object of interest at respective consecutive times in the past. Note that in the case of calculating the moving speed using pieces of object position information at a plurality of times, the moving direction of the object within the period when the plurality of pieces of position information is acquired may not be linear. The generation method determination unit 304 therefore calculates the moving speed between every two pieces of position information among the pieces of object position information at the plurality of times, and calculates an average of the moving speeds of the pairs of pieces of position information as the moving speed based on the object position information at the plurality of times.

In step S602, the generation method determination unit 304 determines whether the moving speed of the object calculated in step S601 is greater than or equal to a predetermined threshold. The processing branches depending on the determination result. If the moving speed of the object is greater than or equal to the threshold (YES in step S602), the processing proceeds to step S603. On the other hand, if the moving speed is less than the threshold (NO in step S602), the processing proceeds to step S604.

In step S603, the generation method determination unit 304 determines to use a method for reducing the spatial resolution as the method for reducing the volume of transmission data.

In step S604, the generation method determination unit 304 determines to use a method for reducing the temporal resolution as the method for reducing the volume of transmission data.

After the method for reducing the volume of transmission data is determined by the processing of step S603 or S604, the processing proceeds to step S506 of FIG. 5.

In step S506, the processing branches depending on which the transmission data volume reduction method determined in step S505 is, the method for reducing the spatial resolution or the method for reducing the temporal resolution. Specifically, if the transmission data volume reduction method determined in step S505 is the method for reducing the temporal resolution (YES in step S506), the processing proceeds to step S507. On the other hand, if the method is that for reducing the spatial resolution (NO in step S506), the processing proceeds to step S508.

In step S507, the generation method determination unit 304 determines the method for reducing the temporal resolution to be used. Details will be described below. In step S507, as temporal resolution reduction method determination processing, the generation method determination unit 304 performs processing for determining which one of a plurality of temporal resolutions to use based on the volume of transmission data before reduction and the available transmission bandwidth.

In step S508, the generation method determination unit 304 determines the method for reducing the spatial resolution too be used. Details will be described below. In step S508, as spatial resolution reduction method determination processing, the generation method determination unit 304 performs processing for determining which one of a plurality of different spatial resolutions to use based on the volume of transmission data before reduction and the available transmission bandwidth.

After the processing of step S507 or S508, the processing proceeds to step S509.

In step S509, the data generation unit 305 generates the transmission data 308 from the three-dimensional model data 306.

For example, in the case where the data volume is determined to not need to be reduced in step S504 and the processing proceeds to step S509, the data generation unit 305 generates the transmission data 308 based on the temporal resolution and spatial resolution of the default values.

In the case where the processing proceeds from step S504 to step S505 and further from S506 to step S509 via step S507, the data generation unit 305 generates the transmission data 308 with the spatial resolution of the default value and the temporal resolution determined in step S507.

In the case where the processing proceeds from step S504 to step S505 and further from step S506 to step S509 via step S508, the data generation unit 305 generates the transmission data 308 with the temporal resolution of the default value and the spatial resolution determined in step S508.

The transmission data 308 generated by the processing of step S509 is then output from the transmission data generation unit 104.

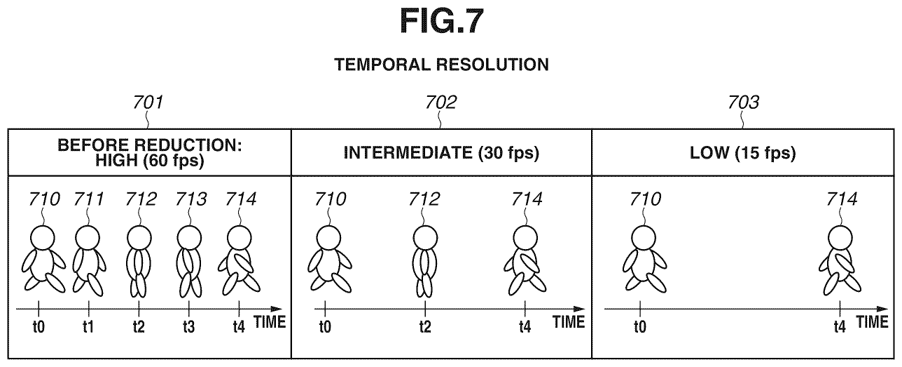

FIG. 7 is a diagram illustrating examples of the temporal resolution determined by the generation method determination unit 304. FIG. 7 illustrates three temporal resolutions, namely, temporal resolution: high 701 of 60 fps, which is the default value, temporal resolution: intermediate 702 of 30 fps, and temporal resolution: low 703 of 15 fps. These are only examples, and the frame rate settings of the temporal resolution may be further subdivided.

At temporal resolution: high 701 of FIG. 7, the frame rate is 60 fps in time intervals from time t0 to time t1, from time t1 to time t2, from time t2 to time t3, and from time t3 to time t4. An object 710 at time t0, an object 711 at time t1, an object 712 at time t2, an object 713 at time t3, and an object 714 at time t4 represent the positions and postures of the object at the respective times.

At temporal resolution: intermediate 702 of FIG. 7, the frame rate is 30 fps in time intervals from time t0 to time t2 and from time t2 to time t4. The object 710 at time t0, the object 712 at time t2, and the object 714 at time t4 represent the positions and postures of the object at the respective times. In other words, in the case of temporal resolution: intermediate 702, the frame-to-frame time interval is 1/30 sec, and the positions and postures of the object are those at every 1/30 sec.

At temporal resolution: low 703 of FIG. 7, the frame rate is 15 fps in a time interval from time t0 to time t4. The object 710 at time t0 and the object 714 at time t4 represent the positions and postures of the object at the respective times. In other words, in the case of temporal resolution: low 703, the frame-to-frame time interval is 1/15 sec, and the positions and postures of the object are those at every 1/15 sec.

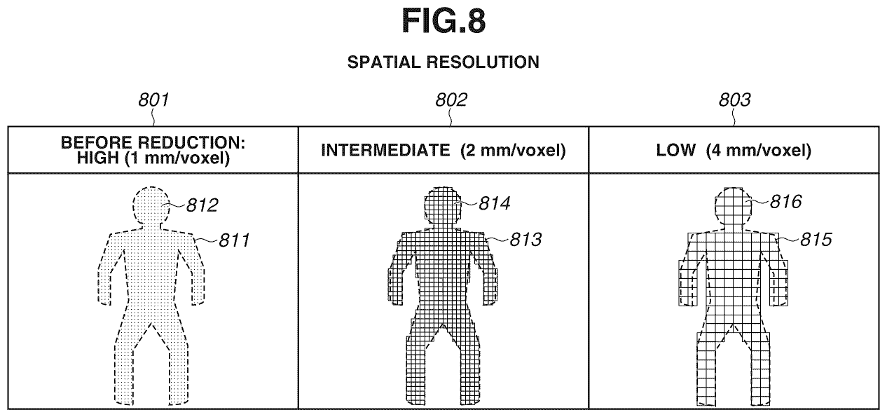

FIG. 8 is a diagram illustrating examples of the spatial resolution determined by the generation method determination unit 304. FIG. 8 illustrates three spatial resolutions, namely, spatial resolution: high 801 of 1 mm/voxel, which is the default value, spatial resolution: intermediate 802 of 2 mm/voxel, and spatial resolution: low 803 of 4 mm/voxel. These are only examples, and the voxel size settings of the spatial resolution may be further subdivided.

At spatial resolution: high 801 of FIG. 8, a three-dimensional model 811 of the object is constructed by combining voxels 812 of 1 mm/voxel, which is the default value.

At spatial resolution: intermediate 802 of FIG. 8, a three-dimensional model 813 of the object is constructed by combining voxels 814 of 2 mm/voxel.

At spatial resolution: low 803 of FIG. 8, a three-dimensional model 815 of the object is constructed by combining voxels 816 of 4 mm/voxel.

If the data volume is determined to not need to be reduced in step S504, the generation method determination unit 304 determines the temporal and spatial resolutions to be the default values illustrated in FIGS. 7 and 8. More specifically, the generation method determination unit 304 determines the temporal resolution to be temporal resolution: high 701 of 60 fps, and determines the spatial resolution to be spatial resolution: high 801 of 1 mm/voxel. As a result, the data generation unit 305 generates transmission data 308 in which the frame-to-frame time interval is 1/60 sec, the position and posture of the object are expressed at 1/60-sec intervals, and the three-dimensional model of the object is constructed using combinations of voxels of 1 mm/voxel.

By contrast, in the case where the processing proceeds to step S507, the generation method determination unit 304 determines to use either temporal resolution: intermediate 702 of 30 fps or temporal resolution: low 703 of 15 fps, based on temporal resolution: high 701 of 60 fps which is the default value. More specifically, the generation method determination unit 304 determines to use either one of temporal resolution: intermediate 702 of 30 fps and temporal resolution: low 703 of 15 fps that are temporal resolutions with reduced frame rates, based on the volume of transmission data before reduction and the available transmission bandwidth. Note that, in step S507, the generation method determination unit 304 determines the spatial resolution to be spatial resolution: high 801 of 1 mm/voxel, which is the default value.

For example, if temporal resolution: intermediate 702 is determined to be used, the frame-to-frame time interval is 1/30 sec. In such a case, the data generation unit 305 reduces the volume of transmission data by selecting frames at predetermined intervals, such as every other frame, from the base 60-fps frames. In the example of FIG. 7, the data generation unit 305 generates data at 30 fps that is temporal resolution: intermediate 702 by selecting the frames at times t0, t2, and t4, and deleting the frames at times t1 and t3. The volume of transmission data when temporal resolution: intermediate 702 is determined to be used is thereby reduced to ½ compared to with temporal resolution: high 701 before reduction.

For example, if temporal resolution: low 703 is determined to be used, the frame-to-frame time interval is 1/15 sec. In such a case, the data generation unit 305 reduces the volume of transmission data by selecting frames at predetermined intervals, such as every fourth frame, from the base 60-fps frames. In the example of FIG. 7, the data generation unit 305 generates data of 15 fps that is temporal resolution: low 703 by selecting the frames at times t0 and t4, and deleting the frames at times t1, t2, and t3. The volume of transmission data when temporal resolution: low 703 is determined to be used is thereby reduced to ¼ compared to with temporal resolution: high 701 before reduction.

The method for reducing the temporal resolution is not limited to simple deletion of frames as described above. Frame data to be actually used as transmission data may be interpolated using the data from the unused frames. For example, voxel information may be interpolated through application of blur processing in relative directions of voxels in the unused frames.

While the present embodiment is described by using a case where the transmission data is three-dimensional model data as an example, a similar method for reducing temporal resolution can be used even in a case where the transmission data is rendered two-dimensional image data. In other words, even when the transmission data is rendered two-dimensional image data, the method for reducing frames to not be used may be employed depending on the volume of transmission data that needs to be reduced.

Now, in step S508, the generation method determination unit 304 determines to use either spatial resolution: intermediate 802 of 2 mm/voxel or spatial resolution: low 803 of 4 mm/voxel, based on spatial resolution: high 801 of 1 mm/voxel, which is the default value.

More specifically, the generation method determination unit 304 determines to use either one of spatial resolution: intermediate 802 of 2 mm/voxel and spatial resolution: low 803 of 4 mm/voxel that are spatial resolutions with larger voxel sizes, based on the volume of transmission data before reduction and the available transmission bandwidth. Note that, in step S508, the generation method determination unit 304 determines the temporal resolution to be temporal resolution: high 701 of 60 fps, which is the default value.

For example, if spatial resolution: intermediate 802 is determined to be used, the three-dimensional model 813 of the object is constructed using voxels 814 of 2 mm/voxel. In such a case, the data generation unit 305 selects one in eight 1-mm voxels included in a 2-mm voxel. Alternatively, the data generation unit 305 may determine presence or absence of voxels by selecting one in eight 1-mm voxels by majority vote, or by comparing the eight 1-mm voxels with thresholds to select one. The voxel color may also be determined by selecting that of a representative voxel or determining the average color of the eight 1-mm voxels.

For example, if spatial resolution: low 803 is determined to be used, the three-dimensional model 815 of the object is constructed using voxels 816 of 4 mm/voxel. Again, the data generation unit 305 determines presence or absence of voxels by selecting one of the 1-mm voxels included in a 4-mm voxel, by majority vote on the 1-mm voxels, or based on thresholds. The voxel color in the case where spatial resolution: low 803 is determined to be used may also be determined by selecting that of a representative voxel or using the average color as described above.

In terms of the number of voxels alone, the spatial resolution-based reduction in the volume of transmission data is to ⅛ with spatial resolution: intermediate 802, and 1/64 with spatial resolution: low 803, relative to spatial resolution: high 801 before reduction. However, voxels constituting the interior of a three-dimensional model typically do not have the same data volume as those on the surface. In reducing the volume of transmission data using the spatial resolution, the amount of reduction in the volume of transmission data is therefore estimated based on a change in the surface area of the three-dimensional model. Consequently, the volume of transmission data reduced using the spatial resolution is approximately ¼ with spatial resolution: intermediate 802, and approximately 1/16 with spatial resolution: low 803, relative to spatial resolution: high 801. The estimation of the amount of reduction, as described above, depends on how the voxel data constituting the three-dimensional model is stored, and thus needs to be calculated based on the data format in the applied system.

The present embodiment has been described by using the case where the transmission data is three-dimensional model data as an example. If the transmission data is rendered two-dimensional image data, the method for reducing spatial resolution reduces the rendering resolution. Such processing may be implemented by determining the rendering resolution based on predetermined amounts of reduction of transmission data corresponding to spatial resolution: intermediate 802 and spatial resolution: low 803. For example, the volume of transmission data may be determined to be approximately ½ with spatial resolution: intermediate 802, and approximately ¼ with spatial resolution: low 803, and the rendering resolution may be determined to implement the data volume.

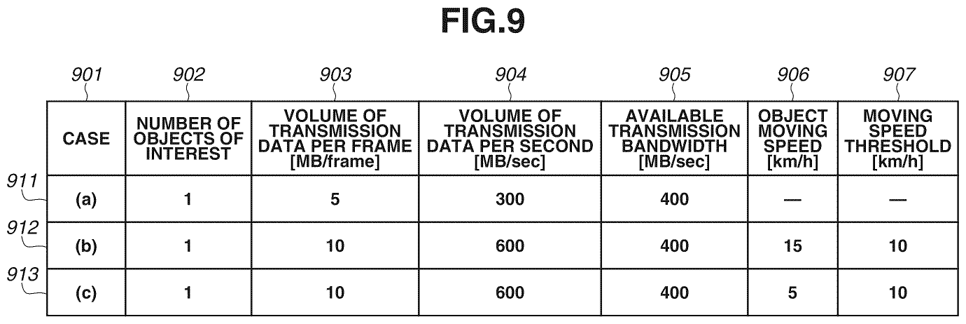

FIG. 9 is a diagram illustrating specific numerical examples when the transmission data generation unit 104 according to the first embodiment described above determines the data volume reduction method.

In FIG. 9, case (a) 911, case (b) 912, and case (c) 913 listed in a case 901 represent examples of situations with respective different object shapes or moving speeds. FIG. 9 illustrates numerical examples of a number of objects of interest 902, a volume of transmission data per frame 903, a volume of transmission data per second 904, an available transmission bandwidth 905, an object moving speed 906, and a moving speed threshold 907 for each case in the case 901.

Data volume reduction method determination processing will now be described along the processing steps of the foregoing flowcharts of FIGS. 5 and 6, in conjunction with each of cases (a) to (c) 911 to 913.

The example of case (a) 911 demonstrates a case where the three-dimensional model data acquired in step S501 of FIG. 5 is data of one object of interest, with the volume of transmission data per frame of 5 MB/frame. Since the default frame rate is 60 fps, it is checked in the transmission data volume check processing of step S502 that the volume of transmission data per second before reduction is 300 MB/sec. In the example of case (a) 911, the available transmission bandwidth acquired in step S503 is 400 MB/sec, for example. In the data volume reduction necessity determination processing of step S504 based on such pieces of information, the volume of transmission data is thus determined to not need to be reduced, since the data volume falls within the available transmission bandwidth. The processing proceeds to step S509, and the transmission data 308 is generated without reducing the volume of transmission data.

The example of case (b) 912 demonstrates a case where the three-dimensional model data acquired in step S501 of FIG. 5 is data of one object of interest, with the volume of transmission per frame of 10 MB/frame. In such a case, it is checked in the transmission data volume check processing of step S502 that the volume of transmission data per second before reduction is 600 MB/sec. Suppose, again, that the available transmission bandwidth acquired in step S503 is 400 MB/sec, for example. Here, in the data volume reduction necessity determination processing of step S504, the volume of transmission data is determined to need to be reduced, since the data volume exceeds the available transmission bandwidth. The processing thus proceeds to step S505.

In step S505, the information about the moving speed of the object of interest and the moving speed threshold is acquired by the processing of step S601 in FIG. 6. In case (b) 912, the moving speed of the object of interest is 15 km/h and the moving speed threshold is 10 km/h. In the determination processing of step S602, the moving speed of the object of interest is thus determined to be greater than or equal to the threshold, and the processing proceeds to step S603. In step S603, the spatial resolution is determined to be reduced. In FIG. 5, the processing thus proceeds to step S508 via the processing of step S506.

In step S508, a reduction method is determined by taking into account how much the spatial resolution needs to be reduced for the data volume to fall within the available transmission bandwidth. In case (b) 912, the volume of transmission data before reduction is 600 MB/sec and the available transmission bandwidth is 400 MB/sec.

In other words, the volume of transmission data before reduction can be accommodated within the available transmission bandwidth if reduced by half, for example. In the spatial resolution reduction method determination processing of step S508, spatial resolution: intermediate 802 of FIG. 8 is thus determined to be used, whereby the volume of transmission data is reduced to 300 MB/sec. In the case where the processing proceeds to step S508, temporal resolution: high 701 of 60 fps, which is the default value, is used as the temporal resolution. In step S509, the transmission data 308 is thus generated at 60 fps and 2 mm/voxel.

To put another way, what the result of the example of case (b) 912 means is that if the moving speed of the object is greater than or equal to the threshold, priority is given to the reproduction of the object's movement, and transmission data including three-dimensional models maintaining the temporal resolution (frame rate) is generated.

In the example of case (c) 913, like the example of the foregoing case (b) 912, the processing proceeds from step S501 to step S505. In case (c) 913, in step S601 of FIG. 6, the moving speed of the object of interest is 5 km/h and the moving speed threshold is 10 km/h. In step S602, the moving speed of the object of interest is thus determined to be less than the threshold, and the processing proceeds to step S604. In other words, in case (c) 913, the temporal resolution is determined to be reduced in step S603. In FIG. 5, the processing thus proceeds to step S507 via the processing of step S506.

In step S507, a reduction method is determined by taking into account how much the temporal resolution needs to be reduced for the data volume to fall within the available transmission bandwidth. In case (c) 913, the volume of transmission data before reduction is 600 MB/sec and the available transmission bandwidth is 400 MB/sec.

In other words, the volume of transmission data before reduction can be accommodated within the available transmission bandwidth if reduced by half, for example. In the temporal resolution reduction method determination processing of step S507, temporal resolution: intermediate 702 of FIG. 7 is thus determined to be used, whereby the volume of transmission data is reduced to 300 MB/sec. In the case where the processing proceeds to step S507, spatial resolution: high 801 of 1 mm/voxel, which is the default value, is used as the spatial resolution. In step S509, the transmission data 308 is thus generated at 30 fps and 1 mm/voxel.

To put another way, what the result of the example of case (c) 913 means is that if the moving speed of the object is less than the threshold, priority is given to the reproduction of the shape of the object, and transmission data including three-dimensional models maintaining the spatial resolution is generated.

Each of the foregoing cases 901 has been described by using an example where the number of objects of interest is one. However, the number of objects of interest may be more than one. When there are multiple objects of interest, the object moving speed can be determined by using various methods. Examples include using the moving speed of an object at the center of the image, using the highest moving speed among those of the objects, and using an average moving speed of all the objects of interest.

As described above, the transmission data generation unit 104 according to the present embodiment can reduce the volume of transmission data based on movement information about objects if the data volume reaches or exceeds the available transmission bandwidth. In other words, according to the present embodiment, the volume of transmission data can be efficiently reduced.

### Second Embodiment

In the first embodiment, the volume of transmission data is described to be efficiently reduced using movement information about objects. The following second embodiment deals with an example where the volume of transmission data is reduced by using movement information about the virtual point of view in addition to the movement information about objects. In the second embodiment, components denoted by the same reference numerals as in the first embodiment operate in a similar manner to what is described in the first embodiment. A description thereof will thus be omitted. The system configuration of the second embodiment is similar to that of FIG. 1, and the use case is similar to that of FIG. 2. The hardware configuration of the transmission data generation unit 104 is also similar to that of FIG. 4. Illustration and description thereof will thus be omitted.

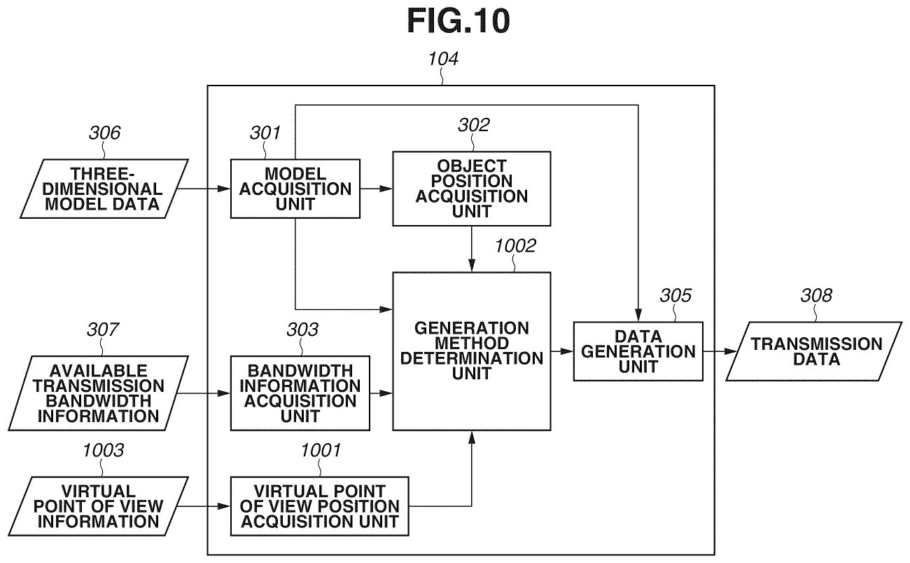

FIG. 10 is a diagram illustrating a functional configuration example where the transmission data generation unit 104 according to the second embodiment can generate transmission data falling within the available transmission bandwidth based on movement information about three-dimensional modeling targets 105, information about the available transmission bandwidth, and movement information about the virtual point of view. The transmission data generation unit 104 according to the second embodiment generates transmission data 308 falling within the available transmission bandwidth based on the three-dimensional model data 306, the available transmission bandwidth 307, and virtual point of view information 1003.

The transmission data generation unit 104 of the second embodiment includes a virtual point of view position acquisition unit 1001. The virtual position information 1003, which is input by the user via the operation unit 211 described above and transmitted from the information transmission unit 212 via the Internet 201, is input to the virtual point of view position acquisition unit 1001. The virtual point of view position acquisition unit 1001 acquires position information about the virtual point of view from the virtual point of view information 1003. The position information about the virtual point of view is sent to a generation method determination unit 1002. Moreover, pieces of position information about past virtual points of view for a certain period from the present (current point in time) are successively stored in the storage device. The position information about the current virtual point of view acquired from the virtual point of view information 1003 and the position information about the past virtual points of view for a certain period stored in the storage device are sent to the generation method determination unit 1002.

The generation method determination unit 1002 according to the second embodiment determines the transmission data generation method based on such pieces of information about the virtual point of view, the three-dimensional model data 306, the position data about the objects (position information about the three-dimensional modeling targets 105), and the available transmission bandwidth information 307. Details of the transmission data generation method determination processing by the generation method determination unit 1002 according to the second embodiment will be described below. The generation method determination unit 1002 sends information indicating the determined transmission data generation method to the data generation unit 305.

As in the example of the foregoing first embodiment, the data generation unit 305 generates the transmission data 308 from the three-dimensional model data 306 or two-dimensional model data, based on the transmission data generation method determined by the generation method determination unit 1002, and outputs the transmission data 308.

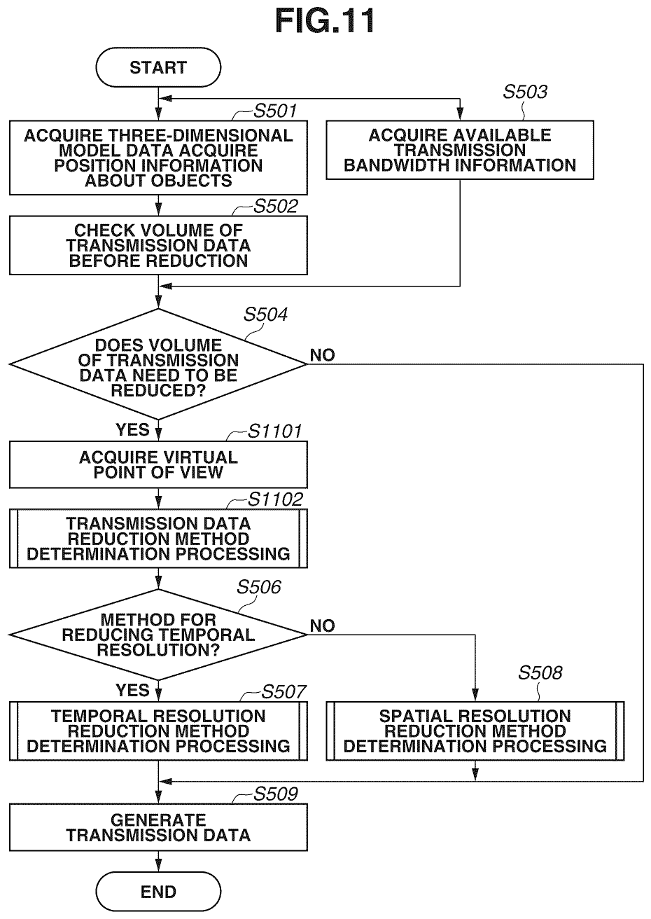

Processing where the transmission data generation unit 104 according to the second embodiment generates the transmission data 308 from the three-dimensional model data 306 based on the position information about objects, the position information about the virtual point of view, and the available transmission bandwidth information will now be described with reference to FIGS. 11 to 13.

FIG. 11 is a flowchart illustrating a procedure for transmission data generation processing performed by the transmission data generation unit 104 according to the second embodiment illustrated in FIG. 10. The processing of steps S501 to S504 is similar to that described with reference to FIG. 5. In the flowchart of FIG. 11, if the data volume is determined to need to be reduced in step S504 (YES in step S504), the processing proceeds to step S1101.

In step S1101, the virtual point of view position acquisition unit 1001 acquires the position information about the virtual point of view from the virtual point of view information 1003. The virtual point of view position acquisition unit 1001 stores the position information about the virtual point of view into the recording device (RAM 403).

In step S1102, the generation method determination unit 1002 determines the method for reducing the volume of transmission data.

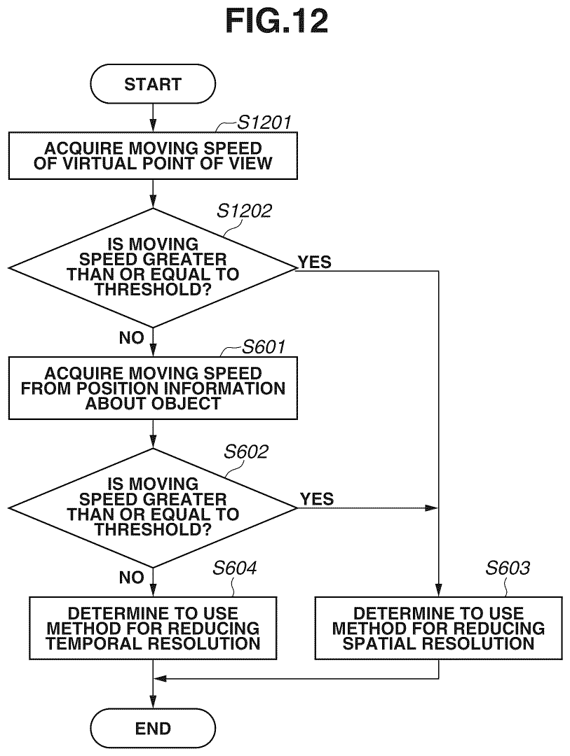

FIG. 12 is a flowchart illustrating a detailed procedure for transmission data reduction method determination processing performed by the generation method determination unit 1002 in step S1102 of FIG. 11.

In step S1201 of FIG. 12, the generation method determination unit 1002 acquires moving speed as movement information about the virtual point of view based on the position information about the current virtual point of view acquired by the virtual point of view position acquisition unit 1001 and the position information about the virtual point of view for a certain period stored in the storage device. Like the processing for calculating the movement information about objects, the moving speed of the virtual point of view can be calculated from position information at two consecutive times and the time difference between the two times, for example. The movement information about the virtual point of view can also be calculated using position information about a plurality of virtual points of view acquired at respective consecutive times in the past. Note that if the moving speed is calculated using the position information about such a plurality of virtual points of view in the past, the moving direction of the virtual point of view within the period when the plurality of pieces of position information is acquired may not be linear. The generation method determination unit 1002, when calculating the moving speed using the plurality of pieces of position information in the past, therefore calculates the moving speed between every two successive pieces of position information, and calculates an average of the moving speeds as the moving speed.

In step S1202, the generation method determination unit 1002 determines whether the moving speed of the virtual point of view is greater than or equal to a predetermined threshold. The processing branches depending on the determination result. If the moving speed of the virtual point of view is greater than or equal to the threshold (YES in step S1202), the processing proceeds to step S603. On the other hand, if the moving speed of the virtual point of view is less than the threshold (NO in step S1202), the processing proceeds to step S601.

The processing of steps S601 to S604 is similar to that described with reference to FIG. 6. A description thereof will thus be omitted.

In the second embodiment, if the moving speed of the virtual point of view is determined to be greater than or equal to the threshold in step S1202, then it is determined in step S603 that the method for reducing the spatial resolution is used with the temporal resolution (frame rate) maintained regardless of the moving speed of objects. In other words, the entire virtual point of view image moves faster the higher the moving speed of the virtual point of view, regardless of the moving speed of objects. The method for reducing the spatial resolution is thus determined to be used.

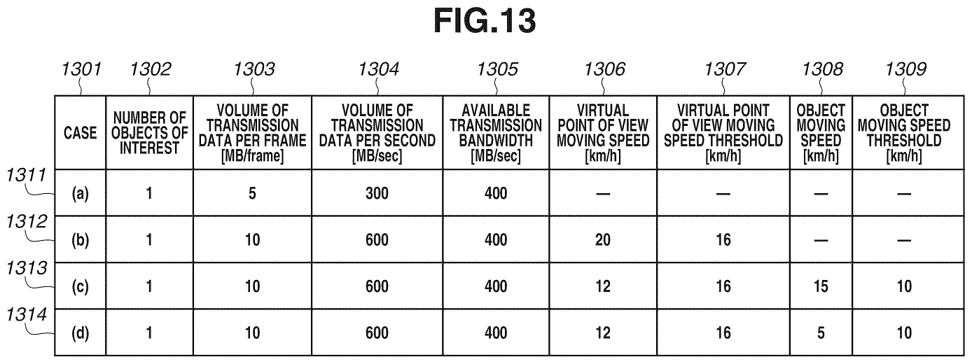

FIG. 13 is a diagram illustrating specific numerical examples when the transmission data generation unit 104 of the second embodiment determines the data volume reduction method.

In FIG. 13, case (a) 1311, case (b) 1312, case (c) 1313, and case (d) 1314 listed in a case 1301 represent examples of situations with respective different object shapes or moving speeds, and different moving speeds of the virtual point of view. FIG. 13 illustrates a number of objects of interest 1302, a volume of transmission data per frame 1303, a volume of transmission data per second 1304, an available transmission bandwidth 1305, an object moving speed 1308, and an object moving speed threshold 1309 for each case in the case 1301. In the second embodiment, a virtual point of view moving speed 1306 and a virtual point of view moving speed threshold 1307 are also added.

The data volume reduction method determination processing will now be described along the processing steps of the foregoing flowcharts of FIGS. 11 and 12, in conjunction with each of cases (a) to (d) 1311 to 1314.

In case (a) 1311, steps S501, S502, and S503 of FIG. 11 provide the same processing results as in case (a) 911 of FIG. 9. More specifically, since the volume of transmission data is within the available transmission bandwidth, the volume of transmission data is determined to not need to be reduced in the data volume reduction necessity determination processing of step S504. The processing proceeds to step S509, and the transmission data 308 is generated without reducing the volume of transmission data.

The example of case (b) 1312 demonstrates a case where the three-dimensional model data acquired in step S501 is data of one object of interest, with the volume of transmission data per frame of 10 MB/frame. In this case, it is checked in the transmission data volume check processing of step S502 that the volume of transmission data per second before reduction is 600 MB/sec. Suppose, again, that the available transmission bandwidth acquired in step S503 is 400 MB/sec, for example. Since the data volume exceeds the available transmission bandwidth, the volume of transmission data is determined to need to be reduced in the data volume reduction necessity determination processing of step S504, and the processing proceeds to step S1101.

In step S1101, information about the moving speed of the virtual point of view and the threshold for the moving speed is acquired by the processing of step S1201 in FIG. 12. In case (b) 1312, the moving speed of the virtual point of view is 20 km/h and the threshold for the moving speed is 16 km/h. In the determination processing of step S1202, the moving speed of the virtual point of view is thus determined to be greater than or equal to the threshold, and the processing proceeds to step S603. In step S603, the spatial resolution is determined to be reduced. In FIG. 11, the processing thus proceeds to step S508 via the processing of step S506.

In step S508, a reduction method is determined by taking into account how much the spatial resolution needs to be reduced for the data volume to fall within the available transmission bandwidth. In the example of case (b) 1312, the volume of transmission data before reduction is 600 MB/sec and the available transmission bandwidth is 400 MB/sec. In other words, the volume of transmission data before reduction can be accommodated within the available transmission bandwidth if reduced by half, for example. In the spatial resolution reduction method determination processing of step S508, spatial resolution: intermediate 802 of FIG. 8 is thus determined to be used, whereby the volume of transmission data is reduced to 300 MB/sec.

In the case where the processing proceeds to step S508, temporal resolution: high 701 of 60 fps, which is the default value, is used as the temporal resolution. In step S509, the transmission data 308 is thus generated at 60 fps and 2 mm/voxel.

In other words, what the result of the example of case (b) 1312 means is that if the moving speed of the virtual point of view is greater than or equal to the threshold, priority is given to the reproduction of the movement of the virtual point of view, and transmission data including three-dimensional models maintaining the temporal resolution (frame rate) is generated.

In the example of case (c) 1313, like the foregoing example of case (b) 1312, the processing proceeds from step S501 to step S505. In case (c) 1313, the moving speed of the virtual point of view is 12 km/h and the threshold for the moving speed is 16 km/h. In step S1201 of FIG. 12, the moving speed of the virtual point of view is thus determined to be less than the threshold, and the processing proceeds to step S601.

In step S601, the generation method determination unit 304 acquires the moving speed of the object of interest and the threshold for the moving speed as described above. In the example of case (c) 1313, the moving speed of the object of interest is 15 km/h and the threshold for the object moving speed is 10 km/h. In step S602, the moving speed of the object of interest is thus determined to be greater than or equal to the threshold, and the processing proceeds to step S603. In other words, the spatial resolution is determined to be reduced, and the processing proceeds to step S508 via step S506 of FIG. 11.

In step S508, a reduction method is determined by taking into account how much the spatial resolution needs to be reduced for the data volume to fall within the available transmission bandwidth. In case (c) 1313, the volume of transmission data before reduction is 600 MB/sec and the available transmission bandwidth is 400 MB/sec. In other words, the volume of transmission data before reduction can be accommodated within the available transmission bandwidth if reduced by half, for example. In the spatial resolution reduction method determination processing of step S508, spatial resolution: intermediate 802 of FIG. 8 is thus determined to be used, whereby the volume of transmission data is reduced to 300 MB/sec. In the case where the processing proceeds to step S508, temporal resolution: high 701 of 60 fps, which is the default value, is used as the temporal resolution. In step S509, the transmission data 308 is thus generated at 60 fps and 2 mm/voxel.

What the result of the example of case (c) 1313 means is that if the moving speed of the object is greater than or equal to the threshold, priority is given to the reproduction of the object movement even when the moving speed of the virtual point of view is less than the threshold. Specifically, in case (c) 1313, transmission data including three-dimensional models maintaining the temporal resolution (frame rate) is generated.

In the example of case (d) 1314, like the foregoing example of case (b) 1312, the processing proceeds from step S501 to step S505. In case (d) 1314, the moving speed of the virtual point of view is 12 km/h and the threshold for the moving speed is 16 km/h. In step S1201 of FIG. 12, the moving speed of the virtual point of view is thus determined to be less than the threshold, and the processing proceeds to step S601.

In step S601, the generation method determination unit 304 acquires the moving speed of the object of interest and the threshold for the moving speed as described above. In the example of case (d) 1314, the moving speed of the object of interest is 5 km/h and the threshold for the object moving speed is 10 km/h. In step S602, the moving speed of the object of interest is thus determined to be less than the threshold, and the processing proceeds to step S604. In other words, the temporal resolution is determined to be reduced. The processing proceeds to step S507 via step S506 of FIG. 11.

In step S507, a reduction method is determined by taking into account how much the temporal resolution needs to be reduced for the data volume to fall within the available transmission bandwidth. In case (d) 1314, the volume of transmission data before reduction is 600 MB/sec and the available transmission bandwidth is 400 MB/sec. In other words, the volume of transmission data before reduction can be accommodated within the available transmission bandwidth if reduced by half, for example. In the temporal resolution reduction method determination processing of step S507, temporal resolution: intermediate 702 of FIG. 7 is thus determined to be used, whereby the volume of transmission data is reduced to 300 MB/sec. In the case where the processing proceeds to step S507, spatial resolution: high 801 of 1 mm/voxel, which is the default value, is used as the spatial resolution. In step S509, the transmission data 308 is thus generated at 30 fps and 1 mm/voxel.

What the result of the example of case (d) 1314 means is that if the moving speeds of the virtual point of view and the object are less than their thresholds, priority is given to the reproduction of the object shape. Specifically, in the example of case (d) 1314, transmission data including three-dimensional models maintaining the spatial resolution is generated.

As described above, the transmission data generation unit 104 of the second embodiment can reduce the volume of transmission data based on the movement information about objects and the virtual point of view if the data volume reaches or exceeds the available transmission bandwidth. In other words, according to the present embodiment, the volume of transmission data can be efficiently reduced.

In the case of the technique described in Japanese Patent Laid-Open No. 2019-54488, the data volume can be reduced by reducing the spatial resolution, but not by reducing the temporal resolution as in the first and second embodiments. For example, even in a scene where an object of interest remains stationary, the technique described in Japanese Patent Laid-Open No. 2019-54488 continues transmitting the transmission data of the stationary object at high frame rate, whereby most of the communication bandwidth is occupied. By contrast, according to the first and second embodiments, even if the available transmission bandwidth is constrained, appropriate transmission data reduction methods can be adopted based on the movement of objects and/or the virtual point of view, whereby degradation of three-dimensional models can be minimized.

### Other Embodiments

In the foregoing first embodiment, the volume of transmission data is described to be reduced based on the information about the available transmission bandwidth and the movement information about objects. In the second embodiment, the volume of transmission data is described to be reduced by separately handling the movement information about objects and the movement information about the virtual point of view. As another embodiment, the volume of transmission data may be reduced based on the information about the available transmission bandwidth and the movement information about the virtual point of view. In such a case, if the moving speed of the virtual point of view is greater than or equal to a threshold, the spatial resolution is determined to be reduced. On the other hand, if the moving speed of the virtual point of view is less than the threshold, the temporal resolution is determined to be reduced.

The first and second embodiments have only dealt with the case where the available transmission bandwidth is satisfied by determining to reduce only one of temporal resolution and spatial resolution. However, both the reduction of temporal resolution and the reduction of spatial resolution may be combined. In the case of combining both, the volume of transmission data can be reduced stepwise by repeating the processing of steps S504 to S509 in the flowchart of FIG. 5 according to the first embodiment or the flowchart of FIG. 11 according to the second embodiment a plurality of times. When the processing of steps S504 to S509 is repeated a plurality of times, the threshold for the object moving speed and the threshold for the moving speed of the virtual point of view may be changed depending on the number of repetitions, and the reduction method may be determined in each repetition loop.

In the second embodiment, the transmission data generation method is determined by acquiring the moving speed of the virtual point of view and the moving speed of objects independently of each other. However, the transmission data generation method may be determined based on a relative moving speed between the virtual point of view and objects. For example, when the virtual point of view and an object are moving in the same direction (their velocity vectors are substantially the same), the object seen from the virtual point of view remains substantially stationary in the virtual point of view image. In such a case, the image quality of the virtual point of view image can rather be maintained higher by maintaining the spatial resolution and reducing the temporal resolution.

An embodiment of the present disclosure can also be implemented by processing for supplying a program for implementing one or more functions of the foregoing embodiments to a system or an apparatus via a network or a storage medium, and reading and executing the program by one or more processors of a computer of the system or apparatus. Circuits (such as ASIC) that implement one or more functions may also be used for implementation.

All of the foregoing embodiments are merely examples of implementation in carrying out the present disclosure, and the technical scope of the present disclosure should not be construed as being limited thereby.

In other words, the present disclosure can be practiced in various forms without departing from the technical concept or essential features thereof.

The disclosure of the foregoing embodiments includes the following configurations, methods, and program.

### (Configuration 1)

There is provided an information processing apparatus comprising:
a bandwidth information acquisition unit configured to acquire information about a transmission bandwidth available for data transmission;
a model acquisition unit configured to acquire a three-dimensional model of an object in a three-dimensional space;
a movement information acquisition unit configured to acquire movement information about at least either the object or a virtual point of view in the three-dimensional space;
a determination unit configured to determine a transmission data generation method based on the information about the transmission bandwidth and the movement information; and
a data generation unit configured to generate transmission data on the three-dimensional model or transmission data on a two-dimensional image generated from the three-dimensional model, based on the transmission data generation method.

### (Configuration 2)

There is provided the information processing apparatus according to configuration 1,
wherein the transmission data generation method includes a plurality of transmission data generation methods for generating transmission data with respective different data volumes, and
wherein the determination unit is configured to determine to use one transmission data generation method among the plurality of transmission data generation methods based on the information about the transmission bandwidth and the movement information.

### (Configuration 3)

There is provided the information processing apparatus according to configuration 2,
wherein the plurality of transmission data generation methods includes a default first transmission generation method and a second transmission data generation method for generating transmission data with reduced data volume compared to the first transmission data generation method, and
wherein the determination unit is configured to determine whether to use the second transmission data generation method, based on the information about the transmission bandwidth and volume of data generated by the first transmission data generation method.

### (Configuration 4)

There is provided the information processing apparatus according to configuration 3,
wherein the second transmission data generation method includes a third transmission data generation method for generating transmission data with reduced temporal resolution and a fourth transmission data generation method for generating transmission data with reduced spatial resolution, and
wherein the determination unit is configured to, in a case where the second transmission generation method is determined to be used, determine to use one of the third transmission data generation method and the fourth transmission data generation method based on the information about the transmission bandwidth and the movement information.

### (Configuration 5)

There is provided the information processing apparatus according to configuration 4,
wherein the movement information acquisition unit is configured to acquire moving speed as the movement information about either the object or the virtual point of view, and
wherein the determination unit is configured to, in a case where the moving speed is greater than or equal to a predetermined threshold, determine to use the fourth transmission data generation method.

### (Configuration 6)

There is provided the information processing apparatus according to configuration 4 or 5,
wherein the movement information acquisition unit is configured to acquire moving speed as the movement information about either the object or the virtual point of view, and
wherein the determination unit is configured to, in a case where the moving speed is less than a predetermined threshold, determine to use the third transmission data generation method.

### (Configuration 7)

There is provided the information processing apparatus according to configuration 4,
wherein the movement information acquisition unit is configured to acquire moving speed of the object and moving speed of the virtual point of view as the movement information about the object and the virtual point of view, and
wherein the determination unit is configured to, in a case where the moving speed of the virtual point of view is greater than or equal to a predetermined threshold, determine to use the fourth transmission data generation unit.

### (Configuration 8)

There is provided the information processing apparatus according to configuration 4 or 7,
wherein the movement information acquisition unit is configured to acquire moving speed of the object and moving speed of the virtual point of view as the movement information about the object and the virtual point of view, and
wherein the determination unit is configured to, in a case where the moving speed of the virtual point of view is less than a predetermined threshold and the moving speed of the object is greater than or equal to a predetermined threshold, determine to use the fourth transmission data generation method.

### (Configuration 9)

There is provided the information processing apparatus according to configuration 4, 7, or 8,
wherein the movement information acquisition unit is configured to acquire moving speed of the object and moving speed of the virtual point of view as the movement information about the object and the virtual point of view, and
wherein the determination unit is configured to, in a case where the moving speed of the virtual point of view is less than a predetermined threshold and the moving speed of the object is less than a predetermined threshold, determine to use the third transmission data generation method.

### (Configuration 10)

There is provided the information processing apparatus according to configuration 4,
wherein the movement information acquisition unit is configured to acquire a relative moving speed between the object and the virtual point of view as the movement information about the object and the virtual point of view, and
wherein the determination unit is configured to, in a case where the relative moving speed is greater than or equal to a predetermined threshold, determine to use the fourth transmission data generation method.

### (Configuration 11)

There is provided the information processing apparatus according to configuration 4 or 10,
wherein the movement information acquisition unit is configured to acquire a relative moving speed between the object and the virtual point of view as the movement information about the object and the virtual point of view, and
wherein the determination unit is configured to, in a case where the relative moving speed is less than a predetermined threshold, determine to use the third transmission data.

### (Configuration 12)

There is provided the information processing apparatus according to any one of configurations 4 to 11, wherein the third transmission data generation method is a method for generating transmission data with reduced frame rate compared to the first transmission data generation method.

### (Configuration 13)

There is provided the information processing apparatus according to any one of configurations 4 to 11, wherein the fourth transmission data generation method is a method for generating transmission data with increased voxel size of the three-dimensional model compared to the first transmission data generation method.

### (Configuration 14)

There is provided the information processing apparatus according to any one of configurations 4 to 11, wherein the fourth transmission data generation method is a method for generating transmission data with reduced rendering resolution of the two-dimensional image compared to the first transmission data generation method.

### (Configuration 15)

There is provided the information processing apparatus according to any one of configurations 5 to 9, wherein the movement information acquisition unit is configured to acquire an average of a plurality of moving speeds calculated using positions of the object at respective consecutive times as the moving speed of the object, the object being an object of interest, or acquire an average of a plurality of moving speeds calculated using positions of the virtual point of view at respective consecutive times as the moving speed of the virtual point of view.

### (Configuration 16)

There is provided the information processing apparatus according to any one of configurations 5 to 9, wherein the movement information acquisition unit is configured to acquire one of the following: moving speed of an object located at a center of a plurality of objects, moving speed of a fastest moving object among the plurality of objects, and an average moving speed of the plurality of objects.

### (Configuration 17)

There is provided the information processing apparatus according to configuration 5 or 6, wherein processing for acquiring the movement information by the movement information acquisition unit and processing for determining the transmission data generation method by the determination unit are repeated a plurality of times while the thresholds are changed based on a number of repetitions.

### (Method 1)

There is provided an information processing method comprising:
acquiring, as bandwidth information acquisition, information about a transmission bandwidth available for data transmission;
acquiring, as model acquisition, a three-dimensional model of an object in a three-dimensional space;
acquiring, as movement information acquisition, movement information about at least either the object or a virtual point of view in the three-dimensional space;
determining a transmission data generation method based on the information about the transmission bandwidth and the movement information; and
generating, as data generation, transmission data on the three-dimensional model or transmission data on a two-dimensional image generated from the three-dimensional model, based on the transmission data generation method.

### (Storage Medium 1)

A storage medium storing a program for causing a computer to function as the information processing apparatus according to any one of configurations 1 to 17.

The present disclosure is not limited to the above embodiments and various changes and modifications can be made within the spirit and scope of the present disclosure. Therefore, to apprise the public of the scope of the present disclosure, the following claims are made.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus comprising:
a bandwidth information acquisition unit configured to acquire information about a transmission bandwidth available for data transmission;
a model acquisition unit configured to acquire a three-dimensional model of an object in a three-dimensional space;
a movement information acquisition unit configured to acquire movement information about at least either the object or a virtual point of view in the three-dimensional space;
a determination unit configured to determine a transmission data generation method based on the information about the transmission bandwidth and the movement information; and
a data generation unit configured to generate transmission data on the three-dimensional model or transmission data on a two-dimensional image generated from the three-dimensional model, based on the transmission data generation method.

2. The information processing apparatus according to claim 1,
wherein the transmission data generation method includes a plurality of transmission data generation methods for generating transmission data with respective different data volumes, and
wherein the determination unit is configured to determine to use one transmission data generation method among the plurality of transmission data generation methods based on the information about the transmission bandwidth and the movement information.

3. The information processing apparatus according to claim 2,
wherein the plurality of transmission data generation methods includes a default first transmission generation method and a second transmission data generation method for generating transmission data with reduced data volume compared to the first transmission data generation method, and
wherein the determination unit is configured to determine whether to use the second transmission data generation method, based on the information about the transmission bandwidth and volume of data generated by the first transmission data generation method.

4. The information processing apparatus according to claim 3,
wherein the second transmission data generation method includes a third transmission data generation method for generating transmission data with reduced temporal resolution and a fourth transmission data generation method for generating transmission data with reduced spatial resolution, and
wherein the determination unit is configured to, in a case where the second transmission generation method is determined to be used, determine to use one of the third transmission data generation method and the fourth transmission data generation method based on the information about the transmission bandwidth and the movement information.

5. The information processing apparatus according to claim 4,
wherein the movement information acquisition unit is configured to acquire moving speed as the movement information about either the object or the virtual point of view, and
wherein the determination unit is configured to, in a case where the moving speed is greater than or equal to a predetermined threshold, determine to use the fourth transmission data generation method.

6. The information processing apparatus according to claim 4,
wherein the movement information acquisition unit is configured to acquire moving speed as the movement information about either the object or the virtual point of view, and
wherein the determination unit is configured to, in a case where the moving speed is less than a predetermined threshold, determine to use the third transmission data generation method.

7. The information processing apparatus according to claim 4,
wherein the movement information acquisition unit is configured to acquire moving speed of the object and moving speed of the virtual point of view as the movement information about the object and the virtual point of view, and
wherein the determination unit is configured to, in a case where the moving speed of the virtual point of view is greater than or equal to a predetermined threshold, determine to use the fourth transmission data generation unit.

8. The information processing apparatus according to claim 4,
wherein the movement information acquisition unit is configured to acquire moving speed of the object and moving speed of the virtual point of view as the movement information about the object and the virtual point of view, and
wherein the determination unit is configured to, in a case where the moving speed of the virtual point of view is less than a predetermined threshold and the moving speed of the object is greater than or equal to a predetermined threshold, determine to use the fourth transmission data generation method.

9. The information processing apparatus according to claim 4,
wherein the movement information acquisition unit is configured to acquire moving speed of the object and moving speed of the virtual point of view as the movement information about the object and the virtual point of view, and
wherein the determination unit is configured to, in a case where the moving speed of the virtual point of view is less than a predetermined threshold and the moving speed of the object is less than a predetermined threshold, determine to use the third transmission data generation method.

10. The information processing apparatus according to claim 4,
wherein the movement information acquisition unit is configured to acquire a relative moving speed between the object and the virtual point of view as the movement information about the object and the virtual point of view, and
wherein the determination unit is configured to, in a case where the relative moving speed is greater than or equal to a predetermined threshold, determine to use the fourth transmission data generation method.

11. The information processing apparatus according to claim 4,
wherein the movement information acquisition unit is configured to acquire a relative moving speed between the object and the virtual point of view as the movement information about the object and the virtual point of view, and
wherein the determination unit is configured to, in a case where the relative moving speed is less than a predetermined threshold, determine to use the third transmission data.

12. The information processing apparatus according to claim 4, wherein the third transmission data generation method is a method for generating transmission data with reduced frame rate compared to the first transmission data generation method.

13. The information processing apparatus according to claim 4, wherein the fourth transmission data generation method is a method for generating transmission data with increased voxel size of the three-dimensional model compared to the first transmission data generation method.

14. The information processing apparatus according to claim 4, wherein the fourth transmission data generation method is a method for generating transmission data with reduced rendering resolution of the two-dimensional image compared to the first transmission data generation method.

15. The information processing apparatus according to claim 5, wherein the movement information acquisition unit is configured to acquire an average of a plurality of moving speeds calculated using positions of the object at respective consecutive times as the moving speed of the object, the object being an object of interest, or acquire an average of a plurality of moving speeds calculated using positions of the virtual point of view at respective consecutive times as the moving speed of the virtual point of view.

16. The information processing apparatus according to claim 5, wherein the movement information acquisition unit is configured to acquire one of the following:
moving speed of an object located at a center of a plurality of objects, moving speed of a fastest moving object among the plurality of objects, and an average moving speed of the plurality of objects.

17. The information processing apparatus according to claim 5, wherein processing for acquiring the movement information by the movement information acquisition unit and processing for determining the transmission data generation method by the determination unit are repeated a plurality of times while the thresholds are changed based on a number of repetitions.

18. An information processing method comprising:
acquiring, as bandwidth information acquisition, information about a transmission bandwidth available for data transmission;
acquiring, as model acquisition, a three-dimensional model of an object in a three-dimensional space;
acquiring, as movement information acquisition, movement information about at least either the object or a virtual point of view in the three-dimensional space;
determining a transmission data generation method based on the information about the transmission bandwidth and the movement information; and
generating, as data generation, transmission data on the three-dimensional model or transmission data on a two-dimensional image generated from the three-dimensional model, based on the transmission data generation method.

19. A storage medium storing a program for causing a computer to function as an information processing apparatus including:
a bandwidth information acquisition unit configured to acquire information about a transmission bandwidth available for data transmission;
a model acquisition unit configured to acquire a three-dimensional model of an object in a three-dimensional space;
a movement information acquisition unit configured to acquire movement information about at least either the object or a virtual point of view in the three-dimensional space;
a determination unit configured to determine a transmission data generation method based on the information about the transmission bandwidth and the movement information; and
a data generation unit configured to generate transmission data on the three-dimensional model or transmission data on a two-dimensional image generated from the three-dimensional model, based on the transmission data generation method.
